(19) United States
(12) Patent Application Publication
(10) Pub. No.: US 2009/0312851 A1
(43) Pub. Date: Dec. 17, 2009

(54) System and Method for Bioprocess Control

(75) Inventor: Soumitra Mishra, Evanston, IL (US)

Correspondence Address: STERNE, KESSLER, GOLDSTEIN & FOX, P.L.L.C., 1100 NEW YORK AVE., N.W., WASHINGTON, DC, 20005, US

(73) Assignee: Biogen Idec MA Inc., Cambridge, MA (US)

(21) Appl. No.: 11/996,672

(22) PCT Filed: Jul. 6, 2006
(86) PCT No.: PCT/US06/26472

§ 371 Date: Nov. 21, 2008

Related U.S. Application Data
(60) Provisional application No. 60/701,988, filed on Jul. 25, 2005.

(51) Int. Cl. G05B 13/04

(52) U.S. Cl. 700/30; 700/90

(57) ABSTRACT

A system and method for controlling a bioprocess equipment (FIG. 1) includes developing a process model. The process model can be applied for process control purposes.

### TECHNICAL FIELD

This invention relates to a system and method for monitoring and controlling a bioprocess.

### BACKGROUND

The manufacture of products such as pharmaceuticals and biologics is highly regulated. Both the production process and the end product must be carefully monitored for adherence to standards and regulations. Variations from the prescribed production method, for example due to equipment failure or raw material variation, can reduce product yield, require additional testing to be performed, or even require the disposal of the product, which can be costly. Operating a manufacturing process within specifications can therefore be an important goal in manufacturing.

A bioprocess for manufacturing of biologics requires control of many process variables, including, for example, temperature, agitation rate, levels of dissolved gases (e.g., O₂, CO₂, etc.), pH, and concentrations of media components and metabolites. A setpoint can be individually determined for each variable, and each variable can be individually controlled, for example, by a proportional-integral-derivative (PID) controller.

### SUMMARY

Improving and maximizing the efficiency and output of a bioprocess (e.g., a fermentation) can require simultaneous control of multiple variables that affect the outcome of the bioprocess. Unlike many manufacturing processes (such as, for example, chemical reactions used in the manufacture of traditional small-molecule pharmaceuticals), bioprocesses can be highly complex, with many interacting variables. The interactions among the variables can be difficult to determine, and therefore are often poorly understood. As a result, control schemes typically rely on individually controlling each variable at or near a defined setpoint. Overall process operations are governed by a standard operating procedure (SOP). However, multivariate analysis of process parameters can reveal that changes in certain parameters have a greater effect on process outcome than others. Using the knowledge of process operations gained by the multivariate analysis, a multivariate statistical process control (MSPC) scheme can be deployed for real-time process control.

Process personnel can use the trajectory to institute preventive controls rather than reactive measures. Harvests can be scheduled at the correct or optimum time between batches rather than on traditional time interval based activities or at the time of failure.

In one aspect, a method of controlling process equipment includes developing a multivariate model of a process, measuring a condition of the process, and comparing the measurement to the model. The process can be a bioprocess.

The method can include altering a condition of the bioprocess based on the comparison. The bioprocess can include culturing any number of types of cells used for production of biomolecules, including, for example, CHO cells or ns0 cells. The model can be a model of a plurality of process steps. Measuring a condition of the bioprocess can include calculating a signature indicative of a plurality of conditions of the bioprocess.

Developing the model can include determining an optimized trajectory for a process variable of the bioprocess. Comparing the measurement to the model can include comparing a measurement of the process variable to the trajectory. The process variable can be a signature indicative of a plurality of conditions of the bioprocess. The method can include altering a condition of the bioprocess based on the comparison. Measuring, comparing and altering can be automated.

In another aspect, a system for controlling process equipment includes a first sub-process unit configured to send a first signal to a control unit. The first signal is indicative of a condition of a process, and the control unit is configured to compare the first signal to a multivariate model of the process. The process can be a bioprocess.

The control unit can be configured to send a second signal to a second sub-process unit, the signal being selected to alter a condition of the bioprocess based on the comparison. The first signal can be indicative of the process variable and the control unit can be configured to compare the first signal to the trajectory. The control unit can be configured to send a second signal to a second sub-process unit, the second signal being selected to alter a condition of the bioprocess based on the comparison.

The details of one or more embodiments are set forth in the accompanying drawings and the description below. Other features, objects, and advantages will be apparent from the description and drawings, and from the claims.

### BRIEF DESCRIPTION OF DRAWINGS

FIG. 1 is a schematic depiction of a bioreactor.

FIGS. 2A and 2B are graphs depicting exemplary process control data.

FIGS. 3A and 3B are graphs depicting multivariate statistical process control (MSPC) unitless signatures.

### DETAILED DESCRIPTION

A process refers to any industrial method by which a product is made. Many industries use some form of process control to ensure that the process operates according to a predetermined specification. In general, process control requires a feedback loop. A measurement of some property of the process is taken and compared to a setpoint value. An output is generated depending on the results of the comparison. The output is designed to adjust the measured property towards the setpoint. The process control is typically automated. The measurement, comparison, and output are typically performed automatically. A user can pre-configure the equipment with respect to, for example, the setpoints and controller sensitivity. A proportional-integral-derivative (PID) controller is one example of a controller that can be used for process control.

In many cases, the industrial process requires a number of properties to be controlled for optimum performance of the process. Some examples of properties that can be controlled (also referred to as process variables) are temperature, pH, pressure, flow velocity, mixing rate, concentration of gases, liquids, or solids, and electrical properties such as conductivity or resistivity. Sometimes, adjusting one process variable influences another process variable. When this is the case, it is said that the control loops are linked or coupled. It can be difficult to determine how (or if) two or more control loops are coupled. Some processes can be very complex, requiring a large number of process steps and having many variables that require control. Although a process may be described in different ways as having a variety of numbers of steps, in one aspect, a process has as few as two process steps, but may also have as many as, for example, 3, 4, 5, 6, 7, 8, 9, 10, 11, 12, 13, 14, 15, 16, 17, 18, 19, 20, 25, 30, 35, 40, 45, 50, 75, 100 or more steps.

One approach to controlling complex processes is the use of statistical process control (SPC). SPC involves using statistical techniques to measure and analyze the variation in processes, for example, in order to monitor product quality and maintain processes to fixed targets. The behavior of a process parameter can be analyzed statistically, determining a mean and standard deviation for the parameter. The standard deviation can be used to help set or adjust upper and lower setpoints for the parameter. SPC can be applied in a univariate or multivariate method.

More than one process parameter can be subjected to statistical analysis using multivariate SPC (MSPC). MSPC can use multivariate statistical models of individual or groups of operations to determine whether process operations or product quality are within specifications. MSPC can be used for real-time monitoring of processes. MSPC software is available from, for example, Emerson Process Management or Umetrics. Commercial MSPC software can provide tools for analyzing process data with multivariate statistics, and for providing feedback to a process for control purposes. However, it alone does not select the desired levels for setpoints and control points for process variables.

MSPC can be used to control all process variables of a process, or a selection of process variables. When fewer than all process variables are controlled by MSPC, the remaining process variables can be controlled by any desired control method. For example, in some embodiments, univariate and multivariate SPC can be used to control the same process. A single process variable can be controlled by univariate SPC, while other additional process variables are controlled by multivariate SPC.

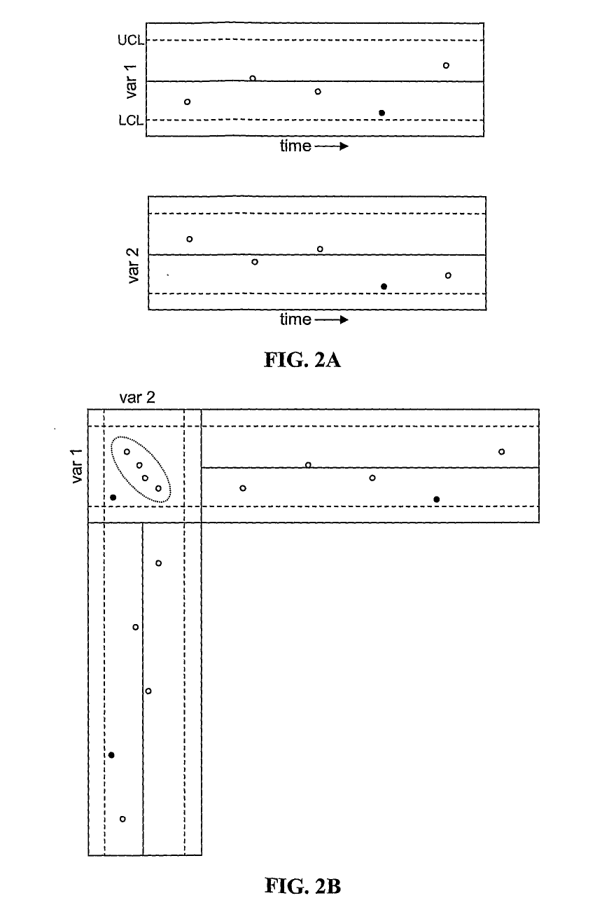

MSPC can provide advantages over other process control schemes, for example, when two or more process variables are correlated. FIG. 2 illustrates such a scenario. FIG. 2A shows the values of two variables (designated var 1 and var 2) plotted as a function of time. Each plot shows the setpoint value (solid line), upper control limit (UCL, dotted line) and lower control limit (LCL, dotted line) for the variable. In each univariate plot, all points fall within the control limits. From FIG. 2B it is apparent that the two variables are correlated when the process is in control. Four of the plotted values falling within the correlated control region (dotted ellipse). In this circumstance, when var 1 and var 2 fall within the ellipse, the process is in control, as shown by the open circles. The process can be out of control even when both var 1 and var 2 fall within their respective nominal control limits (filled circle). The control region can be calculated on a statistical basis, for example, as a selected number of standard deviations from the mean values of var 1 and var 2.

MSPC can use techniques such as principal component analysis (PCA), principal component regression (PCR), partial least squares (PLS), and canonical correlation analysis (CCA). Such techniques can reduce the dimensionality of a data set while retaining as much of the variation contained in the original data as possible.

MSPC is typically used in the optimization or control of a process. Measurements of process variables are provided to a computer running MSPC software. The software analyzes the process variable data. In a process control setting, the software can calculate and provide outputs (i.e., feedback) to the process controls resulting in an adjustment to the level of one or more process variables.

In some embodiments, the MSPC software analyzes the process variable data, but rather than directly controlling process equipment, the analysis is used by an operator to decide how to adjust process variables. The software can provide an display (e.g., on a computer screen, or the like) informing an operator of process conditions. The display can include, for example, one or more control charts indicating whether one or more process variables (or signatures characteristic of more than one process variable) are within control limits. The operator can ascertain from the display whether the process is operating normally or is out of control. The software can be configured to alert an operator when certain conditions occur, particularly conditions that require operator attention. The alert can be in the form of an alarm (audio, visual, or a combination thereof), a page, or an email. Conditions triggering such an alert can include, for example, a process variable being outside control limits, an equipment failure, completion of a process step (e.g., when a time limit expires, or a measured process condition reaches a predetermined value).

A system and method for MSPC can be useful for any complex process, such as, for example a bioprocess. MSPC can be used advantageously in a commercial scale bioprocess. A commercial scale bioprocess can include a variety of process steps, for example, culturing cells in progressively larger volumes; fermentation to produce the desired product; harvesting cells; and purification of the desired product. The yield and quality of the product can be influenced by process conditions at each of these stages. Process operation and control data can be collected during each stage and subjected to multivariate analysis. Multivariate analysis (MVA) of the collected data can be used to predict final outcome (e.g., final product yield and quality) and quality of upstream processes. Multivariate analysis can also be applied to generate a statistical process model. The statistical process model can be integrated with process equipment automation, such that the control model is used to drive the process control systems; in other words, the process variables are controlled according to the statistical process model.

This in turn enables process monitoring, fault detection and rectification (feedback) of the entire upstream operation in an integrated fashion. The process model defines optimal trajectories for each process step and the overall upstream process. The model defines these trajectories in real time as the batch is progressing and also predicts the performance of the currently running batch at the same time.

Application of MSPC for monitoring batch bioreactors has been applied to single process units in a laboratory or a process development setting with little or no automation. Advanced process control techniques (e.g., MSPC) can be combined with process automation to control and provide feedback for a closed loop control system in a bioprocess. The bioprocess can be, for example, a commercial scale bioprocess using any cell type useful in such a process, for example, ns0 or CHO cells. Process automation can be achieved with the aid of, for example, Delta V or PI software (from Emerson Process Management, and OSIsoft, respectively). MSPC techniques can be implemented using, for example, SIMCA P+ and SIMCA Batch On Line (SBOL) software, available from Umetrics.

A model of the bioprocess can be developed in order to predict process outcomes, such as batch yield or quality. The model can be a multivariate model, accounting for the effects of multiple process parameters. The multivariate model can be developed using, for example, SIMCA P+ software. Models can be developed independently for each of several process steps and then combined as a model of the entire process or a portion of the entire process. Integrating models for several process steps helps to utilize the process information from all the stages and incorporate all the process behavior. Optimized process trajectories can be developed. The process can be controlled along a desired trajectory in order to maximize process efficiency. An efficient process can be, for example, one that uses less starting material, provides a higher product yield or a higher quality product, is complete in a shorter period of time, generates less waste, uses less energy, or a combination of these.

Many commercial bioprocess control methods are based on a golden batch. For a given batch, the process variables are controlled with the goal of matching the trajectories recorded in a previous successful batch (the golden batch). Thus, process operations are governed by an inflexible standard operating procedure (SOP) developed retrospectively from the golden batch.

In contrast, multivariate analysis of a bioprocess can allow the development of a model representing behavior of the bioprocess. More particularly, measurements of process parameters are made over the course of batch. The measurements are used as inputs for multivariate analysis to determine, for example, which parameters strongly influence batch properties (e.g., yield and purity) and how parameters influence one another (i.e., which parameters are coupled to other parameters).

The model can guide the advancement of material in a multi-stage process from one stage to the next. For example, in a bioprocess, the model can be used to decide when to transfer a cell culture to a larger vessel, or when to harvest cells from a bioreactor. When operating under an SOP, these actions are carried out without regard for the state of the cell culture. In contrast, when using a process model, an operator can choose to carry out actions when the culture achieves optimal conditions. For example, rather than harvest after a predetermined time has elapsed according to an SOP, an operator can elect to harvest when the cell culture has attained a desired property or set of properties.

A predictable process can be repeated with the same starting material and operating conditions to achieve essentially the same result (i.e., product yield and quality), time after time. Processes that are less predictable can still afford reliable outcomes if sufficient knowledge about the process is available, in particular, how adjusting particular process variables affects outcome. With such knowledge, and a measure of process conditions, an operator can adjust the process during a run to achieve a desired outcome. In general, however, bioprocesses are not predictable processes. Even when the process is repeated with all conditions as closely matched as possible to a prior run, the result can vary. Process knowledge for a bioprocess can be difficult to obtain, and generally, no two bioprocesses are alike. Optimal conditions for a bioprocess can be different for different cell types (e.g., bacterial, eukaryotic, insect, or mammalian, or within different cells or cell lines within a cell type (e.g., CHO cells or ns0 cells), or even for two different products derived from otherwise identical cells. Multivariate analysis of process data can provide empirical process knowledge that can be used to guide process operations.

Optimal process models for a bioprocess will differ for each bioprocess. As an example, a process model can be developed for commercial manufacturing using ns0 and CHO cell lines in small- and large-scale manufacturing situation.

The process model can be integrated with automation systems to control manufacturing equipment. The process model can be implemented with DeltaV, PI, SBOL, and a logical routine developed for the process so that the model can be used for real time process control. The model is based on on/off states of different process units to enable monitoring and prediction for the entire process in real time.

The process model can be derived from a comprehensive dataset based on sensor data for the process units, ancillary devices, and raw materials. The optimal trajectories as defined by the multivariate approach are then used to devise feedback strategies to the automation using the SBOL software. Real-time feedback is sent to the plant automation systems to close the process control loop.

In particular, the system and method can be used advantageously where a high-value product, or a complex-to-manufacture product, that requires many manufacturing steps be carried out according to precise specifications and time constraints. Some examples of industrial equipment, processes, or unit procedures (a unit procedure is typically defined as a sequence of actions, or operations, taking place within the same main piece(s) of equipment) where the system and method can be used include a vessel procedure, such as a process carried out in a stirred tank reactor, a seed reactor, a stirred tank fermentor, a seed fermentor, an air-lift fermentor, a continuous stirred tank reactor, or a plug flow reactor.

Other processes amenable to use with the system and method include, for example: aerobic bio-oxidation (e.g., environmental well mixed, or plug flow oxidations), anaerobic digestion, trickling filtration, anoxic reaction, neutralization, wet air oxidation, and incineration.

The system and method can be used with a filtration process, for example, a microfiltration, an ultrafiltration, or a reverse osmosis process, any of which can be in a batch or continuous (feed-and-bleed)) format. Other filtrations include diafiltration, dead-end, Nutsche, plate & frame, rotary vacuum, air filtration, belt filter press, granular multi-medium, and baghouse filtrations.

Additional processes include, for example, electrostatic precipitation, gas cyclone, hydrocyclone, homogenization, bead milling, and centrifugation. Centrifugation can be carried out with, for example, a decanter centrifuge, a disk-stack centrifuge, a bowl centrifuge, a basket centrifuge (top discharge or bottom discharge), and a centritech centrifuge. Chromatographic processes include processes such as, for example, gel filtration (size exclusion chromatography), adsorptive chromatography in a packed bed or expanded bed column (e.g., ion exchange, affinity, HIC, reverse phase, etc.), ion exchange, mixed-bed ion exchange, and GAC adsorption (for liquid and gaseous streams).

Equipment for drying, for example, a tray dryer, freeze drying (lyophilization) equipment, a double cone dryer, a sphere dryer, a cone screw dryer, a spray dryer, a fluid bed dryer, a drum dryer, a rotary dryer, or a generic sludge dryer can be monitored with the system and method. So can separation equipment, such as equipment for sedimentation (separation of two immiscible liquid phases in a decanter tank), clarification (removal of particulate components in a clarifier), an inclined plate separator, a thickener basin, a dissolved-air flotation tank, or an API oil separator.

Distillation and fractionation (e.g., flash, batch, or continuous), extraction (e.g., mixer-settler extractor, differential (column) extractor, or centrifugal extractor), phase change (e.g., condensation, single- and multiple-effect continuous evaporation, thin film evaporation, crystallization under continuous flow), absorption/adsorption, stripping, and degasification equipment can all be used with the system and method. Likewise, process equipment for storage, (such as, for example, batch and continuous storage in a blending tank, a flat bottom tank, a receiver tank, a horizontal tank, a vertical-on-legs tank, a horizontal tank on wheels, a horizontal tank with mixer, a silo, or a hopper) are suitable for use with the system and method. Other types of equipment envisioned as being used with the present invention can include equalization equipment, a junction box mixer, a heat exchanger or cooling tower, a heat sterilizer, mixing equipment (e.g., bulk flow, mixture preparation, tumble mixer, or discrete flow), splitting equipment (e.g., for bulk flow, multi-way flow distribution, discrete flow, or on a component-by-component basis), and size reduction equipment (for example, bulk or discrete grinding or shredding).

Equipment for formulation and packaging of products (e.g., for extrusion, blow molding, injection molding, trimming, filling, assembly, printing, label attachment, or packing), or for tableting can be monitored by the system and method. Process equipment that is used for transport of products or materials can be monitored as well. Examples of transport equipment include a centrifugal pump, a gear pump, a diaphragm pump, a centrifugal compressor, a centrifugal fan, a belt conveyor (bulk), a belt conveyor (discrete), a pneumatic conveyor (bulk), a pneumatic conveyor (discrete), a screw conveyor (bulk), a screw conveyor (discrete), a bucket elevator (bulk), and a bucket elevator (discrete). Valves can also be monitored, for example, a gate valve, a control globe valve, or a butterfly valve.

Fermentation is one example of a complex process. Typically a fermentation is carried out in a bioreactor. In general, a bioreactor is a device for culturing living cells. The cells can produce a desired product, such as, for example, a protein, or a metabolite. The protein can be, for example a therapeutic protein, for example a protein that recognizes a desired target. The protein can be an antibody. The metabolite can be a substance produced by metabolic action of the cells, for example, a small molecule. A small molecule can have a molecular weight of less than 6,000 Da, 5,000 Da, or less than 1,000 Da. The metabolite can be, for example, a mono- or poly-saccharide, a lipid, a nucleic acid or nucleotide, a polynucleotide, a peptide (e.g., a small protein), a toxin, or an antibiotic.

The bioreactor can be, for example, a stirred-tank bioreactor. The bioreactor can include a tank holding a liquid medium in which living cells are suspended. The tank can include ports for adding or removing medium, adding gas or liquid to the tank (for example, to supply air to the tank, or adjust the pH of the medium with an acidic or basic solution), and ports that allow sensors to sample the space inside the tank. The sensors can measure conditions inside the bioreactor, such as, for example, temperature, pH, or dissolved oxygen concentration. The ports can be configured to maintain sterile conditions within the tank. Other bioreactor designs are known in the art. The bioreactor can be used for culturing eukaryotic cells, such as a yeast, insect, plant or animal cells; or for culturing prokaryotic cells, such as bacteria. Animal cells can include mammalian cells, such as, for example, Chinese hamster ovary (CHO) cells or ns0 cells. In some circumstances, the bioreactor can have a support for cell attachment, for example when the cells to be cultured grow best when attached to a support. The tank can have a wide range of volume capacity—from 1 L or less to 20,000 L or more. For example, a bioreactor train can have tank capacities of 50 L, 150 L, 750 L, 3,750 L, or 20,000 L. In a manufacturing context, a cell culture can be transferred to a bioreactor with a larger tank size in order to increase the volume of the cell culture. The cell culture can be increased in volume according to a predetermined ratio at each step. For example, a culture of CHO cells can be transferred to a bioreactor that has a volume five times larger. Other ratios can apply to other CHO cell processes or types of cells.

A signature can be developed that is indicative of the status of cells in a bioreactor. The signature can reflect process conditions including, for example, viable cell density, pH, concentration of a culture component (e.g., glucose). The signature can be related to cell growth rate. In particular, the signature can indicate when the cells in the bioreactor are approaching a maximum viable density. As the cells approach the maximum viable density, the rate at which the cells reproduce slows. If the cells are too close to the maximum viable density when transferred to a larger bioreactor, the time required for the cells to reproduce to high density can be longer than if the transfer were made earlier. Thus, in order to maintain a high growth rate (and therefore minimize total time required for cell growth), it can be important to transfer cells to larger bioreactors at the appropriate time. The particular conditions that contribute to the signature, and the values of the signature that indicate a transfer is due, can be different for different cell lines. For example, CHO cells and ns0 cells can have different signatures that indicate when transfer to a larger bioreactor is due. Even for two CHO cell lines that produce different products (e.g., a desired polypeptide) can have different signatures. The signatures can only be developed empirically, that is, by collecting and analyzing process data for the particular cell line for which a signature is desired.

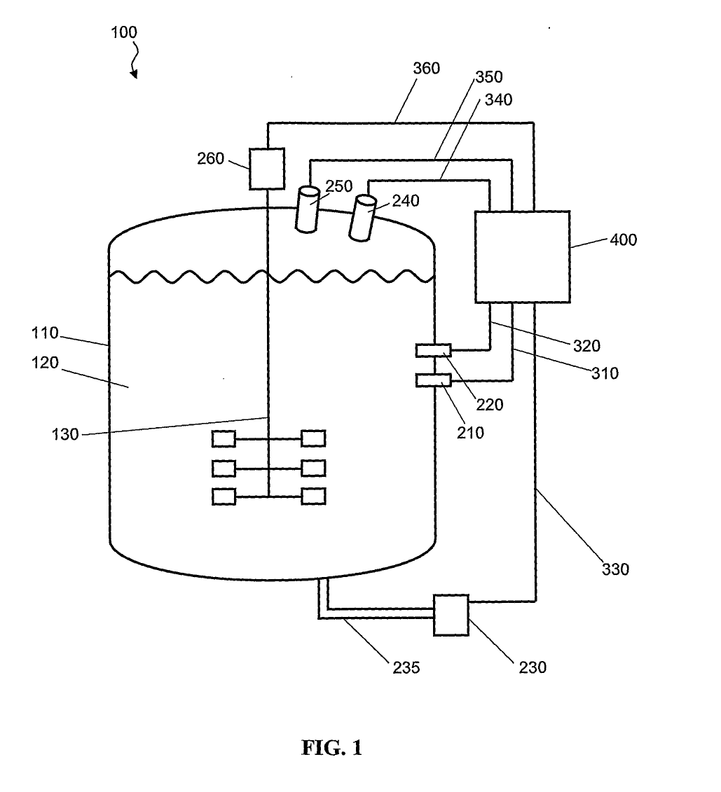

Referring to FIG. 1, process unit 100 is demonstrated as a liquid reactor, such as a bioreactor. Process unit 100 includes vessel 110, holding liquid cell culture 120 which can be stirred by agitator 130. Process unit 100 further includes sub-process units 210, 220, 230, 240, 250 and 260. For the purposes of exemplifying the variety of sub-process units that can be associated with process unit 100, sub-process unit 210 can be a pH meter; unit 220 an oxidation-reduction potential (ORP) meter; unit 230 a flow controller for gas supply 235; units 240 and 250 can be acid and base pumps, respectively, for pH control; and unit 260 can be a motor for agitator 230. Each sub-process unit 210, 220, 230, 240, 250 and 260 is connected via communication channels 310, 320, 330, 340, 350 and 360, respectively, to control system 400. Channels 310, 320, 330, 340, 350 and 360 can carry an analog signal, a digital signal, or both an analog and digital signal. In some embodiments, a digital signal provides a measure of a primary variable (such as pH or ORP), and the digital signal includes a measure of a secondary variable. The secondary variable can provide information about the operational status, diagnostics, or health of the unit. The channel can use an industrial communication protocol, such as, for example, HART™, FOUNDATION™ Fieldbus, Devicenet, or Profibus. The communication channel can carry a signal from a sub-process unit (e.g., a measurement signal) or to a sub-process unit (e.g., a control signal).

A number of process units may be used to complete a process. For example, a commercial scale bioprocess may require the cultivation of a large quantity of cells in a high volume bioreactor. The cells, however, may grow most efficiently at moderate densities, and therefore it can be desirable to cultivate the cells in progressively larger bioreactors until a desired quantity of cells is reached. Although a sequence of bioreactors (i.e., process units) is used, the cultivation can be considered a single process.

Control system 400 can include an MSPC system. The MSPC system can accept inputs from sub-process units 210, 220, 230, 240, 250 and 260 via channels 310, 320, 330, 340, 350 and 360. The inputs can convey information about the operational status of the sub-process units. The inputs can include an analog or digital signal. The MSPC system can calculate one or more signatures based on the inputs. The signature can reflect the status of the inputs, indicating whether the process is operating within specifications. The control system can compare the signature to a predefined trajectory. If the signature falls outside the trajectory (i.e., outside predefined control limits), the system can send a control signal to one or more sub-process units. The control signal is chosen to drive the process toward the trajectory.

Control system 400 can include a display screen to provide a graphical view of the signature to an operator or user. The overall optimal trajectory is displayed on a client interface, which can be provided by SBOL server. This would provide manufacturing, engineering, process development and maintenance personnel a quick and convenient way of monitoring the progress of a batch to make sure that the manufacturing process was operating as intended and the process was running normally. It also allows personnel to monitor process upsets, detect the cause of the upset and rectify the abnormality in real time, thus preventing batch failures. The process can automatically correct itself based on the designed feedback loop. One such feedback strategy is optimum harvest time strategy based on the optimal trajectory: the process automatically stops after reaching a defined endpoint. The feedback could provide appropriate set points to all the sensors and controllers to reach the optimal endpoint.

Process models can be developed that include and integrate operations of ancillary units, upstream or downstream process units like centrifuges or microfiltration units, purification columns, water purification units, clean-in-place and sterilize-in-place schemes, raw material characterization operations, and the like.

The capability has been demonstrated for the CHO cell line for three main units in the entire upstream process. The routine is developed internally and the logic is available to be extended to entire upstream process. Advanced monitoring technologies like NIR Spectroscopy and Raman Spectroscopy techniques also could be included in the advanced process control strategy process.

The sub-process units can provide data to MSPC software for process control purposes. For example, a pH meter can be used for measuring pH in a process control context. A sub-process unit can additionally deliver multiple signals related to its status (i.e., diagnostic signals) to a control system. The measurement signal and diagnostic signals can be transmitted as a digital signal. For example, the pH meter can use a digital communication protocol to transmit one or more diagnostic variables to a control system, in addition to the pH measurement. The diagnostic variable can be, for example, glass impedance, reference impendence or resistance temperature detector (RTD) resistance.

The diagnostic variable can be an input to an MSPC system. The MSPC system can accept input from multiple sub-process units. The input can provide information about the operational status of the sub-process unit.

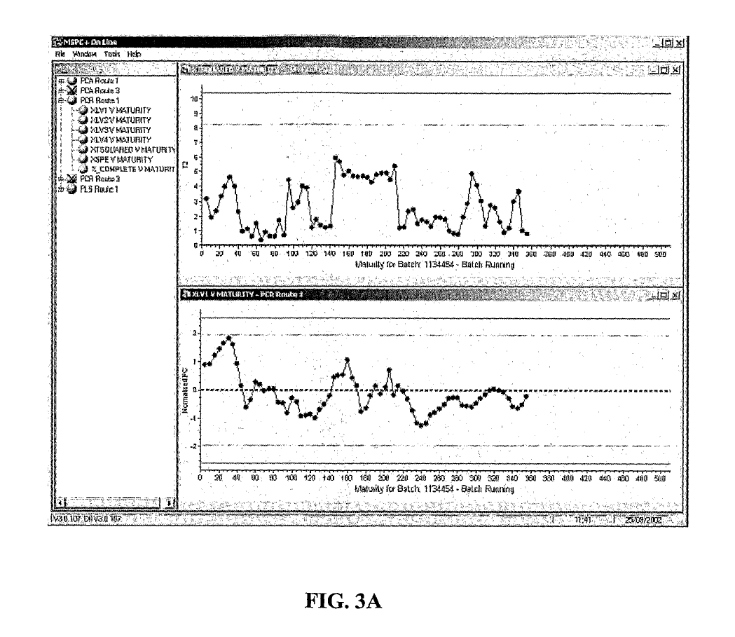

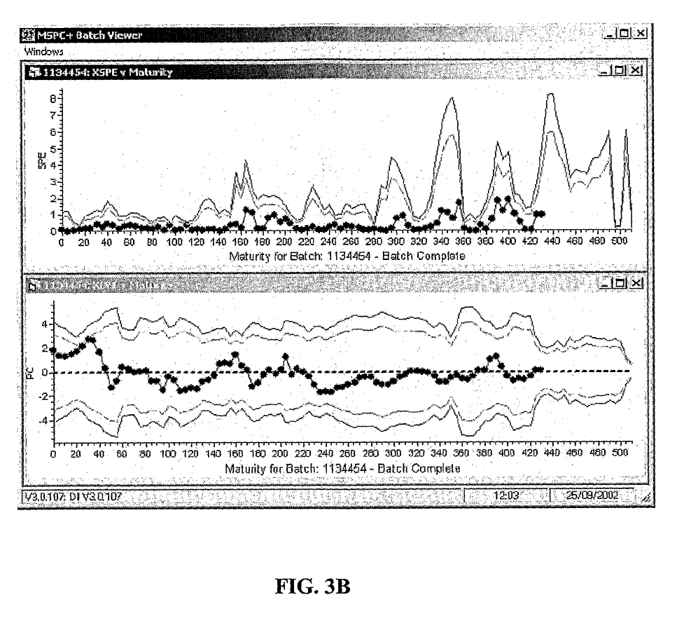

Referring to FIGS. 3A and 3B, multivariate statistical process control (MSPC) signatures can be displayed graphically. In this example a number of inputs (e.g., XLV1V MATURITY, XLV2V MATURITY, XLV3V MATURITY, XLV4V MATURITY) are used to create and plot a number of multivariate analytical traces, for example, T², normalized principal component, squared predicted error and principal component versus batch maturity. Each trace has a y-axis that is essentially unitless and is a statistical composite of the contribution of each input variable.

MSPC methods can be used to provide a signature, or signatures, for the inputs to the MSPC analysis. The signature can be a variable that changes as a function of time. Each signature can be associated with one or more threshold values. When a signature exceeds a threshold (i.e., is greater than an upper threshold or less than a lower threshold), it can be an indication of abnormal operation. A signature built on multivariate SPC techniques can detect abnormal operations with greater sensitivity than univariate SPC monitoring. Each signature can be displayed graphically. A signature can be, for example, a T² statistic or SPE statistic. Use of a T² statistic in MSPC is described in, for example, Multivariate Statistical Process Control with Industrial Application by Robert Lee Mason, and John C. Young, Society for Industrial and Applied Mathematics, 2001, which is incorporated by reference in its entirety. Each signature can include more than one variable. For example, a signature can be displayed as a graph showing a first principal component (as determined by PCA) on one axis and a second principal component on another axis, or a T² or SPE chart.

One or more signatures can be developed for each process unit or sub-process unit. The signatures can be displayed one at a time, in groups, or all at once on a graphic screen (e.g., a computer display). Two or more groups of equipment each having its own signature, or signatures, can be monitored by a single composite signature. The composite signature can indicate the status of, for example, a manufacturing line, the equipment in one area or floor of a plant.

Multiple signals can contribute to a signature. For example, a signature can be calculated based on 1, 2 or more, 5 or more, 10 or more, 20 or more, or 30 more signals. A single input can contribute to more than one signature. When a large number of signals (e.g., 30 or more) is available for a process unit, a smaller number of signatures can be generated, helping to simplify monitoring of the equipment for an operator. Expressed mathematically, a matrix N×P (representing variables×observations) can be transformed into a matrix K×P where K<<N, and K represents the calculated signatures.

A master health indicator graphic screen can show all the signatures for a process unit, a manufacturing system or line, or an entire facility. Manufacturing, engineering and maintenance personnel can quickly and conveniently refer to this display to survey the facility to make sure that all equipment is working as intended. Each signature can be calculated and displayed in real time.

The signature (or signatures) can also be stored for future reference and record-keeping purposes. A record of each signature can be stored, for example, on paper records, or on a machine-readable medium (e.g., floppy disk, hard disk drive, CD-ROM, or the like). The stored signature can be associated with a product. For example, a radio frequency identification (RFID) tag can be physically associated with a product, and information relating to the manufacture of the product (e.g., a signature) can be stored in a memory on the RFID tag. See, for example, U.S. Pat. No. 6,839,604, which is incorporated by reference in its entirety.

A number of embodiments have been described. Nevertheless, it will be understood that various modifications may be made. Accordingly, other embodiments are within the scope of the following claims.

What is claimed is:

1. A method of controlling process equipment, comprising:
developing a multivariate model of a process;
measuring a condition of the process; and
comparing the measurement to the model.

2. The method of claim 1, wherein the process is a bioprocess.

3. The method of claim 2, wherein the bioprocess includes culturing CHO cells or ns0 cells.

4. The method of claim 1, further comprising altering a condition of the process based on the comparison.

5. The method of claim 1, wherein the model is a model of a plurality of process steps.

6. The method of claim 1, wherein measuring a condition of the process includes calculating a signature indicative of a plurality of conditions of the process.

7. The method of claim 1, wherein developing the model includes determining an optimized trajectory for a process variable of the process.

8. The method of claim 7, wherein comparing the measurement to the model includes comparing a measurement of the process variable to the trajectory.

9. The method of claim 7, wherein the process variable is a signature indicative of a plurality of conditions of the process.

10. The method of claim 9, wherein comparing the measurement to the model includes comparing a measurement of the process variable to the trajectory.

11. The method of claim 10, further comprising altering a condition of the process based on the comparison.

12. The method of claim 11, wherein measuring, comparing and altering are automated.

13. A system for controlling process equipment, comprising:
a first sub-process unit configured to send a first signal to a control unit, wherein the first signal is indicative of a condition of a process, and wherein the control unit is configured to compare the first signal to a multivariate model of the process.

14. The system of claim 13, wherein the process is a bioprocess.

15. The system of claim 13, wherein the control unit is configured to send a second signal to a second sub-process unit, the signal being selected to alter a condition of the process based on the comparison.

16. The system of claim 13, wherein the process includes culturing CHO cells or ns0 cells.

17. The system of claim 13, wherein the model is a model of a plurality of process steps.

18. The system of claim 13, wherein the model includes an optimized trajectory for a process variable of the process.

19. The system of claim 18, wherein the first signal is indicative of the process variable and the control unit is configured to compare the first signal to the trajectory.

20. The system of claim 18, wherein the process variable is a signature indicative of a plurality of conditions of the process.

21. The system of claim 20, wherein the first signal is indicative of the process variable and the control unit is configured to compare the first signal to the trajectory.

22. The system of claim 21, wherein the control unit is configured to send a second signal to a second sub-process unit, the second signal being selected to alter a condition of the process based on the comparison.
